(19) United States
(12) Patent Application Publication
(10) Pub. No.: US 2019/0095915 A1
(43) Pub. Date: Mar. 28, 2019

(54) SYSTEM AND METHOD FOR MANAGING RECURRING PAYMENTS

(71) Applicant: MASTERCARD INTERNATIONAL INCORPORATED, Purchase, NY (US)

(72) Inventors: Amarildo Gjondrekaj, Yonkers, NY (US); Benjamin M. Berger, Rye Brook, NY (US)

(21) Appl. No.: 15/718,223

(22) Filed: Sep. 28, 2017

(51) Int. Cl. G06Q 20/40; G06F 17/30

(52) U.S. Cl. CPC G06Q 20/405; G06F 17/30964

(57) ABSTRACT

A system and method for managing a recurring payment between a merchant and a consumer with a recurring payment management (RPM) system as an interface between a consumer and one or more merchant recurring payment systems. The RPM system obviates the need for the consumer to individually manage his/her recurring payment obligations by acting as a gatekeeper to manage each of a plurality of recurring payments for a plurality of merchants over a plurality of merchant recurring payment systems.

### FIELD OF THE INVENTION

The present invention relates to an improved system and method for managing recurring payments.

### BACKGROUND OF THE INVENTION

Authorized recurring payments benefit consumers and merchants by automating payment for goods and/or services the consumer has previously agreed to purchase on a regular and recurring basis. A recurring payment may be a fixed amount (e.g., for an annual subscription), or it may be a variable amount based upon usage.

To take advantage of authorized recurring payments, the consumer must provide authorization to the merchant to automatically process the recurring payment and access the consumer's designated payment method for the authorized amount. Authorized recurring payments are then processed by the merchant at a predefined frequency or when the balance in the account reaches a certain threshold. Typical examples include subscription services like NetFlix®, EasyPass®, or PlayStation® LinkedIn® annual memberships. The consumer benefits by maintaining continuity of service with ensured payment of service/membership fees. The merchant benefits from guaranteed and regular payment of service/membership fees.

However, for consumers it may be a case of “out of sight, out of mind,” with consumers not paying attention to such recurring payments—specifically, to the amount of such payments. It is possible that a merchant increases the amount of a recurring payment without permission from the consumer and by only notifying the consumer via a monthly statement. It is also possible that a consumer is unaware of such an increase. Having been previously authorized by the consumer, the now increased recurring payment if processed automatically. Unless a consumer chooses to be involved in the recurring payment process by reviewing monthly statements, control of the process rests mainly with the merchant to the extent that a merchant can increase a subscription fee and process recurring payments without consumer approval.

It is also a challenge for a consumer to manage multiple recurring payments. Each recurring payment is managed by the specific merchant with whom the consumer has contracted for services/membership, and for whom the consumer has authorized a recurring payment. It is not uncommon for a consumer to have such relationships and to have provided such authorization to a plurality of merchants. Each merchant provides and manages its own recurring payment system, and interacts directly with consumers. Managing these relationships and authorization by a consumer requires the consumer to engage directly with each merchant. Such a task can easily become daunting and unmanageable for consumers.

### SUMMARY OF THE INVENTION

The present invention is directed to a system and method for managing a recurring payment between a merchant and a consumer. In accordance with embodiments of the present invention, a recurring payment management (RPM) system is an interface between a consumer and one or more merchant recurring payment systems. Using a specific system architecture, arrangement and operation of various components, the present invention achieves an unconventional technological solution to a technical problem. The unconventional technological solution is in providing a gatekeeper between a consumer and a plurality of merchant recurring payment systems—a one (consumer) to one (RPM system) to many (merchants)—that will require consumer authorization before a recurring payment is processed when the merchant has changed the amount of the payment. The system and method of the present invention are operationally and structurally different from the prior art. Operationally, the present invention establishes a new relationship between the consumer and merchant for recurring payments. Currently, it is a one (consumer) to many (merchant) relationship that places the burden on the consumer to ensure the recurring payments are in line with what the consumer had initially authorized with each merchant. With the present invention, the operational relationship is one (consumer) to one (RPM system) to many (merchants), shifting the burden of managing the recurring payments for a plurality of merchants from the consumer to the RPM system and transferring control over management of recurring payments from the merchant to the RPM system. The consumer no longer needs to manage recurring payment relationships with a plurality of merchants, as that task is now handled by the RPM system. With the present invention, the consumer need only manage a single relationship with the RPM system. Architecturally, the present invention provides a RPM system (comprised at least of a server and database) located between the consumer and a plurality of merchants. The RPM system may reside in a cashless transaction card network (through which cashless transaction are processed, including recurring payment transactions), or elsewhere provided that the RPM system is the gatekeeper interface between the consumer and a merchant or a plurality of merchants for recurring payment transactions.

To utilize the present invention, a consumer first creates an account with the RPM system by providing at least one account (i.e., a cashless transaction card account number) to which an authorized recurring payment can be charged. The consumer also identifies at least one merchant from which a request for a recurring payment may be considered for processing by the RPM system. The consumer also provides an authorized amount for the recurring payment. Other information relating to the merchant and services provided in exchange for the recurring payment by the consumer may also be provided by the consumer. In a preferred embodiment, an issuer of the cashless transaction card (and account) is the interface with the consumer to provide access to the present invention. The issuer will enable a consumer to access the present invention, and will provide the consumer information to the RPM system.

The RPM system, in turn, creates a database entry for the consumer in a database of the RPM system. The database has a plurality of database records for a plurality of consumer cashless transaction card accounts. Each of the plurality of database records for each of the plurality of accounts has at least one merchant and a recurring payment amount limit that represents the amount approved by the consumer for a recurring payment to the identified merchant. Each database record may also have a recurring payment amount variable indicating an allowable variation of the recurring payment amount. After the consumer has established a consumer account, and the RPM system has created a database entry for the consumer, the RPM system communicates with a plurality of merchant recurring payment systems. For each consumer and consumer account in the database, the RPM system will communicate with the merchant recurring payment system for the merchant associated with the consumer account. Each time the RPM system receives a request from a merchant for a recurring payment for which a consumer has created a database entry, the RPM system of the present invention compares the amount of the recurring payment request from the merchant with the recurring payment amount limit (+/−the allowable variation) for this specific merchant and for this specific recurring payment. If the amounts are the same or, if changed, within the amount limit+/−the allowable variation, the recurring payment is authorized and processed. If the amounts are not the same, the RPM system transmits a message to the consumer indicating that a request for a recurring payment has been received for an amount that has not been authorized. The message transmitted to the consumer, in addition to advising of the situation, queries the consumer as to whether the payment is authorized. The consumer can respond by authorizing the payment once (i.e., pay this time only), authorizing the payment this time and for future requests for the same amount, or denying the payment.

The present invention thus provides an improved system and method for managing recurring payments. Advantageously, the present invention provides a RPM system between the consumer and the merchant payment systems that obviates the need for the consumer to communicate with the different merchant payment systems of each of the different merchants for which the consumer has authorized a recurring payment.

### DESCRIPTION OF THE DRAWINGS

Embodiments of the present invention will now be described with reference to the following figures, wherein:

FIG. 1 depicts a recurring payment system in accordance with the prior art;

FIG. 2 depicts a recurring payment system in accordance with embodiments of the present invention;

FIG. 3 depicts a recurring payment management system in accordance with the prior art;

FIG. 4 depicts a recurring payment system in accordance with embodiments of the present invention;

FIG. 5 is a flow diagram of a method for managing a recurring payment in accordance with the prior art;

FIGS. 6A and 6B are a flow diagram of a method for managing a recurring payment management system in accordance with embodiments of the present invention;

FIG. 7 is a block diagram of a server of a recurring payment management system for managing recurring payments in accordance with embodiments of the present invention;

FIGS. 8A and 8B are flow diagrams of a process for creating a recurring payment management account in accordance with embodiments of the present invention; and

FIG. 9 is a block diagram of the interconnection between a recurring payment management system and a merchant recurring payment system for managing recurring payments in accordance with the present invention.

### DESCRIPTION OF EMBODIMENTS OF THE INVENTION

As used herein, the term “connectable” refers to various states of connection between electronic devices. For example, “connectable” refers to a physical connection between electronic devices, a wireless connection between electronic devices, a combination of a physical and wireless connection between electronic devices, a transient or episodic connection between electronic devices. As used herein the term “connectable” also refers to various states of connectivity between electronic devices such as, by way of non-limiting example, when electronic devices are not connected, when electronic devices are connecting or disconnecting, and when electronic devices are connected.

As used herein, the term “acquirer” refers to bank that processes and settles a merchant's payment card transactions, and then in turn settles those transactions with the card issuer. Merchants maintain accounts with acquirers to ensure the merchants receive payment for cashless transactions. An acquirer may function as payment gateway that provides a merchant service to authorize cashless transactions. The payment gateway may be provided by a bank to its customers, but can be provided by a specialized financial service provider as a separate service.

As used herein, the term “issuer” refers to a financial institution, bank, credit union or company that issues cashless transaction cards to consumers. As used herein the term “cashless transaction” refers to a transaction among a user using a cashless transaction card, e.g., credit card, debit card, gift card, etc., a merchant, and an issuer of the cashless transaction card. As used herein, “cashless transaction cards” refer both to physical cards, as well as to electronic accounts that do not utilize a physical card to complete a financial transaction, such as electronic wallets and other electronic payment applications.

Referring next to the drawings in detail, embodiments of the present invention will now be discussed. With reference to FIGS. 1, 3 and 5, a prior art merchant recurring payment system 60 is depicted. Each merchant 10 maintains its own merchant recurring payment system 60. Although not shown in FIG. 1, an acquirer bank 70 may be part of the merchant recurring payment system 60. A single consumer 30 must communicate (i.e., establish an account, authorize a recurring payment, monitor the recurring payments, etc.) with each merchant 10 for which the consumer 30 has authorized a recurring payment. For many consumers 30, this is something that is overlooked or forgotten once the recurring payment has been authorized, resulting in the recurring payments occurring without consumer oversight. While other entities may be involved in processing payments between a consumer 30 and merchant 10, FIG. 1 depicts the entities having primary control over the recurring payment process—the consumer 30 and the merchant 10. Importantly, if a consumer is not engaged in managing this process (e.g., by checking monthly statements), control over the process may rest entirely with the merchant 10.

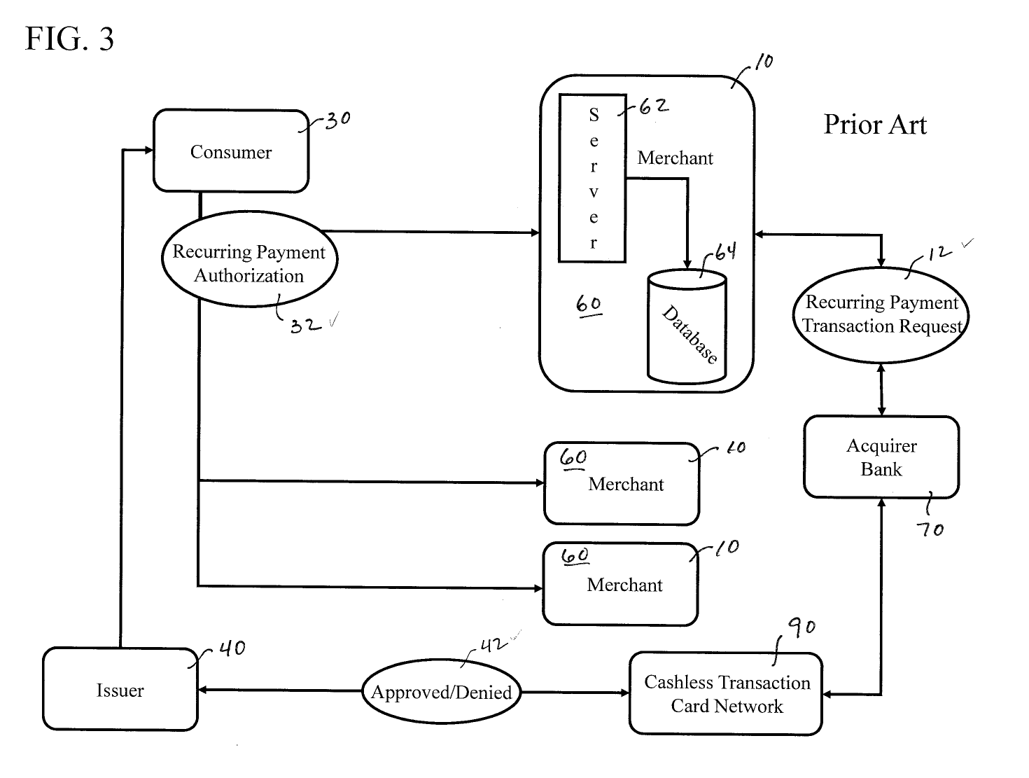

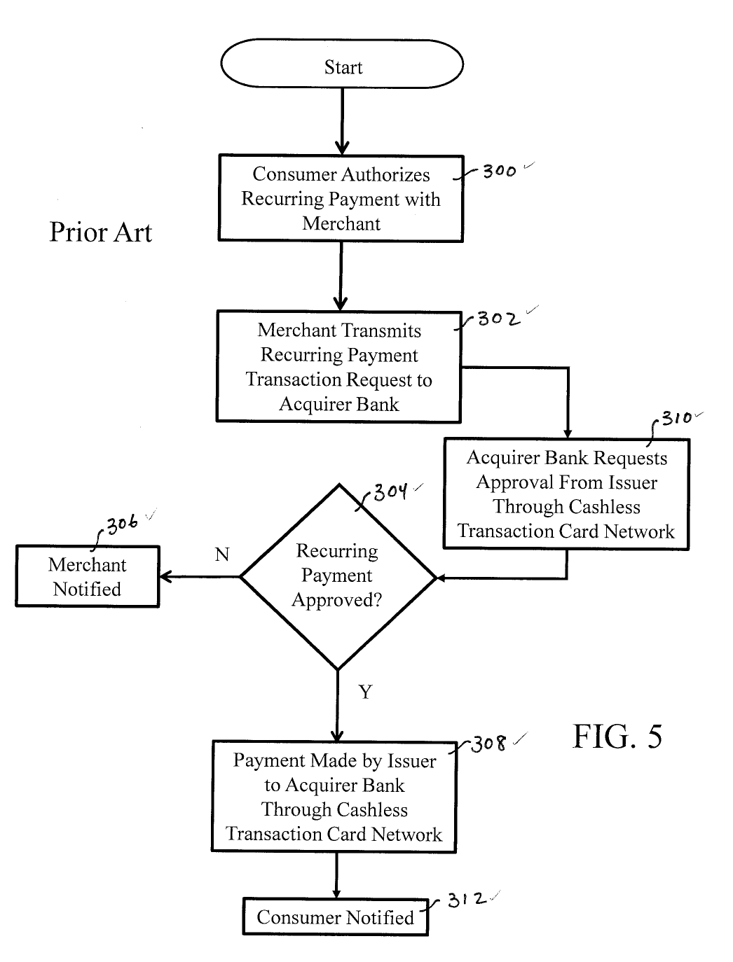

To initiate a recurring payment, a consumer 30 first authorizes the merchant 10 to automatically charge the consumer 30 for services provided by the merchant 10, at 300 in FIGS. 5 and 32 in FIG. 3. For example, if the merchant is NetFlix®, the consumer 30 authorizes NetFlix® to automatically charge the consumer 30 each month for the amount of the subscription plan selected by the consumer 30. This authorization does not always limit the merchant 10 to a fixed dollar amount for the recurring payment, and may be an open-ended authorization for the merchant 10 to charge the consumer 30 account for charges incurred during a billing period. In some cases, the incurred charges may be fixed, such as for a monthly subscription not dependent upon usage. In other cases, the incurred charges may vary month-to-month, such as for charges based upon consumer usage. In either case the merchant 10 may increase the recurring charge without the consumer's 30 knowledge, and sometimes without requiring further authorization from the consumer 30. Once a recurring payment is authorized by the consumer 30, the merchant 10 regularly submits a recurring payment transaction request to an acquirer bank 70, 302 in FIGS. 5 and 12 in FIG. 3—the regularity of the merchant recurring payment request depending upon the terms initially agreed to by the consumer 30 and merchant 10. The periodicity may be monthly, quarterly, semi-annually or annually, as examples. The recurring payment transaction request may alternatively be submitted by the merchant 10 when a balance in the consumer 30 account hits a predefined amount, such as for EasyPass® or similar services. In response to receiving a recurring payment transaction request, the acquirer bank 70 transmits an approval request to an issuer 40 through a cashless transaction card network 90, at 310. The issuer 40 decides, at 304 in FIGS. 5 and 42 in FIG. 3, whether to approve or deny the transaction request. The issuer 40 will either approve or deny the request based upon factors such as the amount of the recurring payment in view of the consumer credit limit, or balance in a debit card account. The issuer 40 communicates an approval or denial of the request message back to the acquirer bank 70. If the transaction request is approved by the issuer 40, payment is made by the issuer 40 to the acquirer bank 70 (and to the merchant 10) through the cashless transaction card network 90 at 308. The consumer 30 is also notified, at 312, on his/her monthly statement for the account to which the recurring payment is applied. This is the only involvement of the consumer 30 after the recurring payment was initially authorized. If the transaction is denied, the acquirer bank 70 transmits that message to the merchant 10 at 306. Thus, in prior art systems, approval of a recurring payment transaction request is not based upon whether an amount previously agreed to by a consumer and merchant has been changed by the merchant.

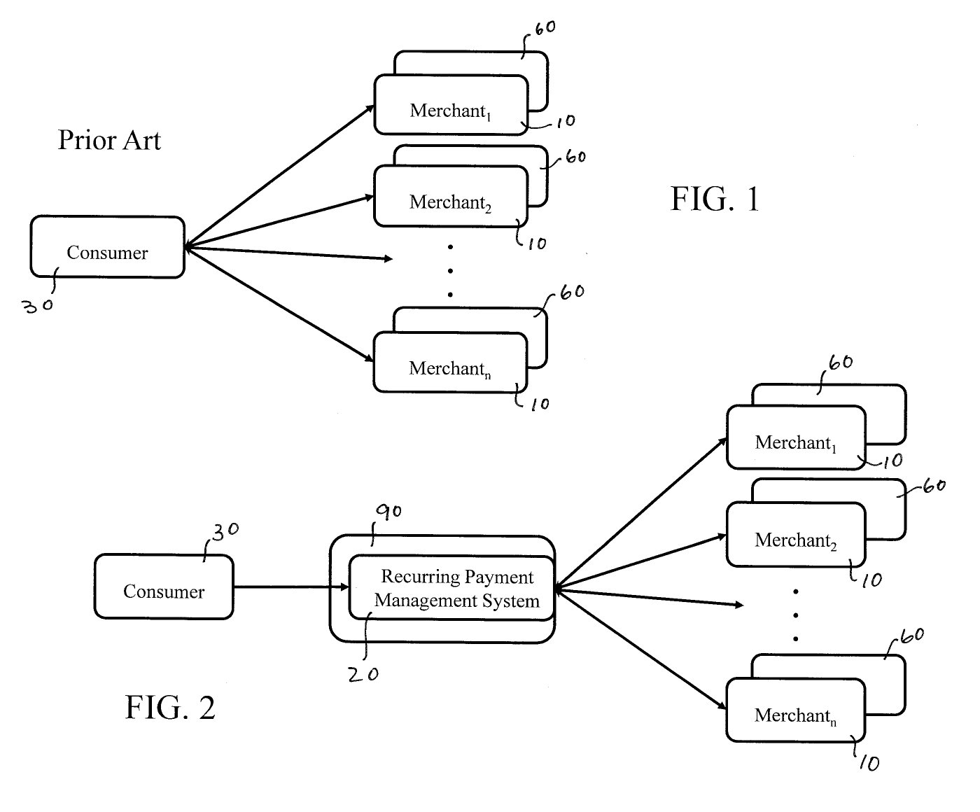

Referring next to FIGS. 2, 4, 6A and 6B, an embodiment of the present invention will now be discussed in detail. The present invention provides an improved method and system for managing a recurring payment that provides a new configuration of systems and components and improves consumer control over recurring payments. The present invention provides an unconventional technological solution to the technological problem of managing recurring payments by placing control over a recurring payment directly with the consumer 30 when the amount of a previously authorized recurring payment has been changed—typically increased, although the present invention also covers a decrease in a recurring payment. The present invention also advantageously places this control with the consumer 30 in real-time when a recurring transaction request is being processed for payment. Thus, with the present invention the consumer 30 has control over whether to authorize a recurring payment that has been changed. The system of the present invention is an innovative and unconventional solution to the technological problem of managing recurring payments—more specifically, of a consumer managing a plurality of recurring payments for a plurality of merchants over a plurality of merchant recurring payment systems. The system of the present invention obviates the need for the consumer to individually manage his/her recurring payment obligations by acting as a gatekeeper to manage each of a plurality of recurring payments for a plurality of merchants over a plurality of merchant recurring payment systems. The system of the present invention also notifies the consumer 30 when the amount of a previously authorized recurring payment has changed (i.e., increased or decreased), and places control over whether to authorize payment of the change amount with the consumer 30.

The present invention provides not only an improved system architecture for recurring payments, the present invention also provides improved operation of a recurring payment system. The system architecture is improved by providing a RPM system between a consumer and many merchants. This enables a consumer to easily manage a plurality of recurring payments with a plurality of merchants via a single interface with the RPM system. Operation of a recurring payment system is improved by the present invention by involving the consumer in real-time during a recurring payment transaction request to approve or deny the transaction if the amount of the recurring payment is different from the amount previously authorized by the consumer.

In accordance with embodiments of the present invention, a recurring payment management (RPM) system 20 is provided in a cashless transaction card network 90 and is comprised of a server 22 and a database 24 having a plurality of database records 80 for a plurality of consumer accounts. Each database record 80 may be for one consumer account 82 (i.e., for one consumer cashless transaction card and account number), but may contain a plurality of entries 84 for a plurality of merchants 10, each entry also having a merchant identifier for a merchant 10. Since a consumer 30 may use a cashless transaction card (i.e., an account) for purchases at a plurality of merchants 10, and consequently may authorize recurring payments for a plurality of merchants 10, the database record 80 for the consumer account 82 may contain entries for each of the authorized recurring payments with the plurality of merchants 10. Each record 80 will also contain an amount limit 86 for which the recurring payment is authorized, and may contain an allowable variation 88 of the authorized amount limit 86.

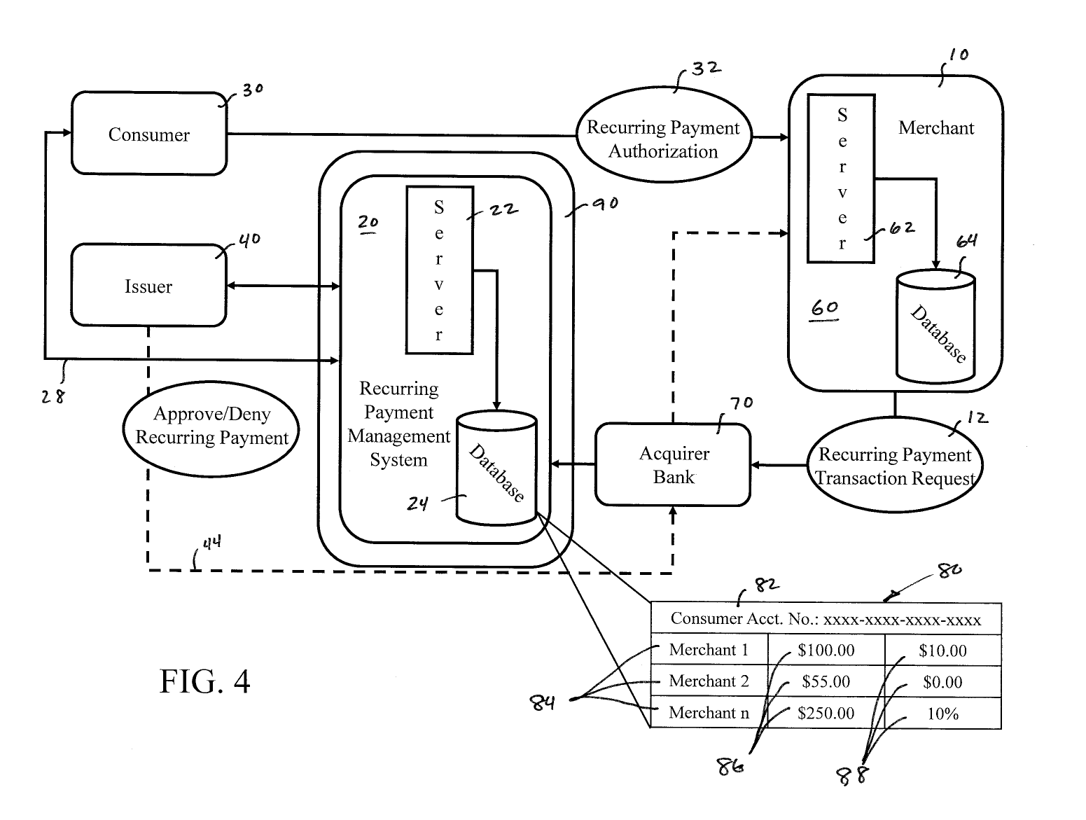

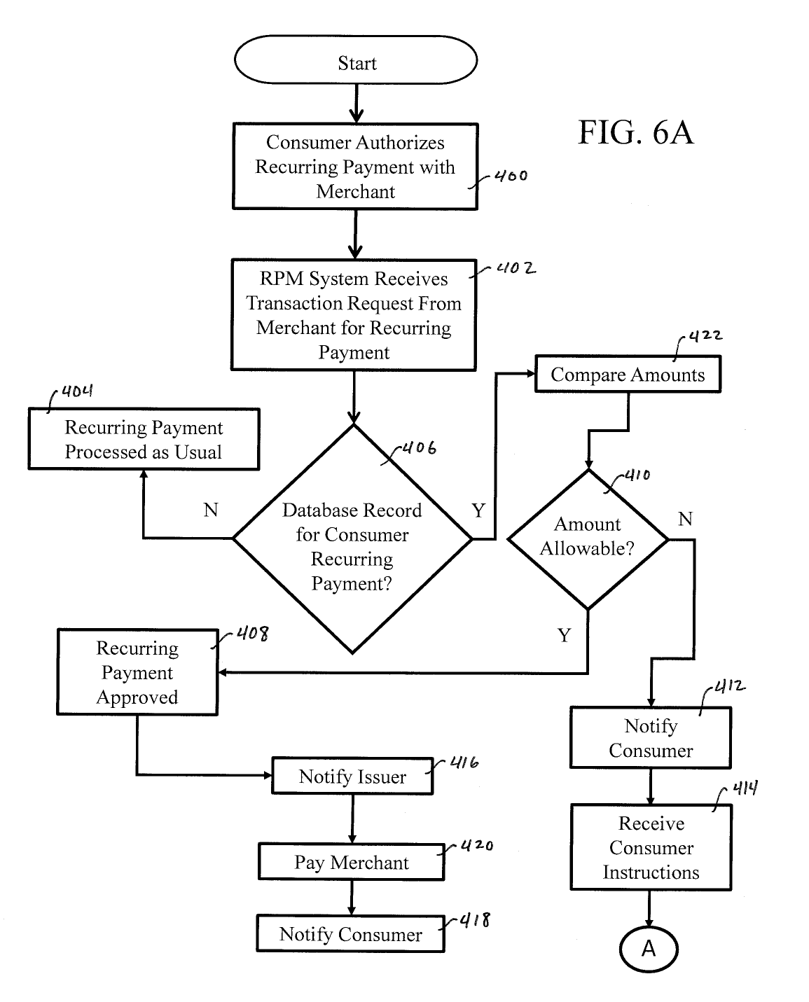

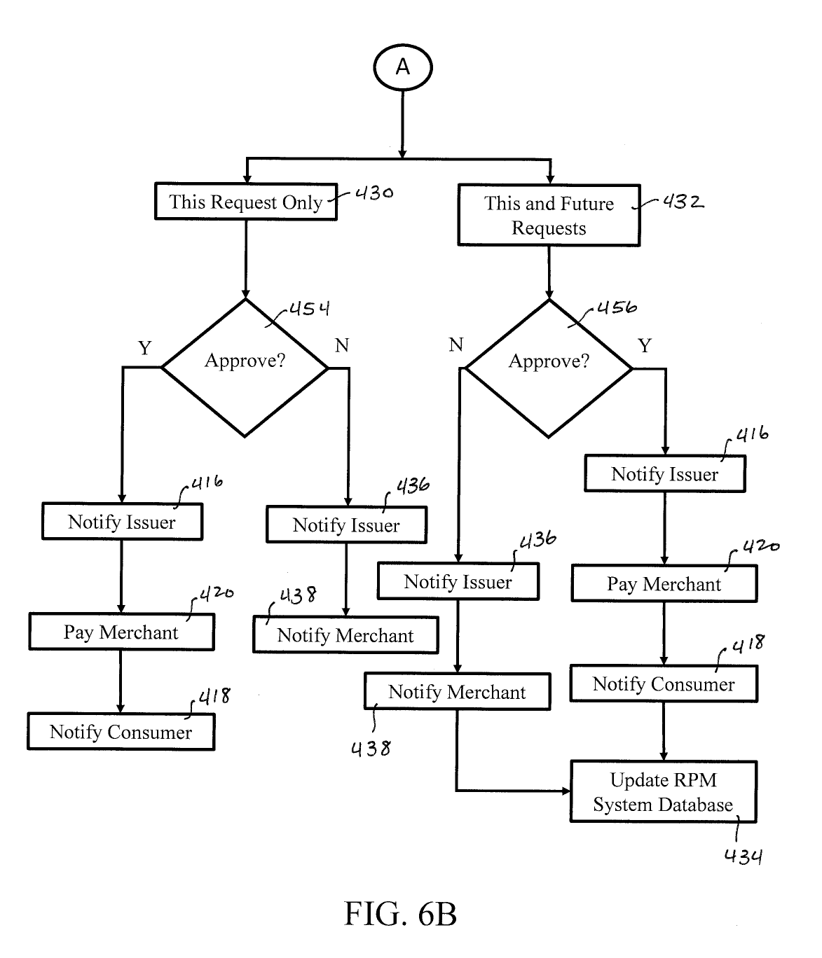

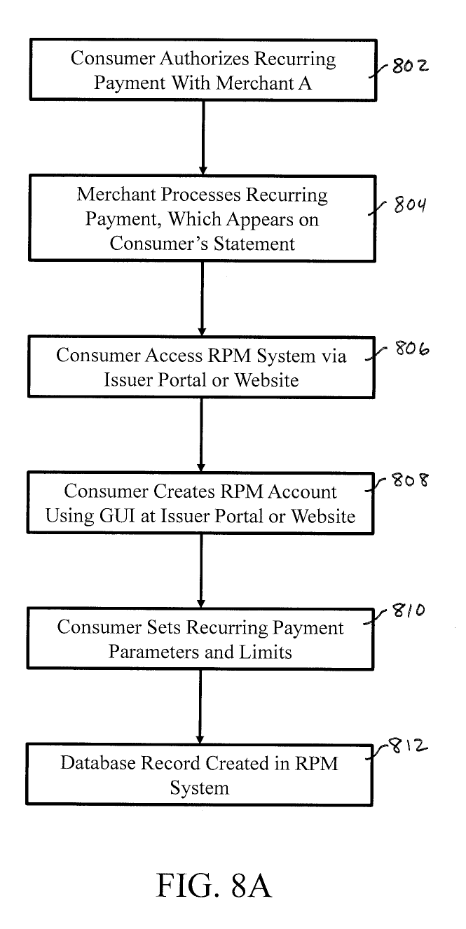

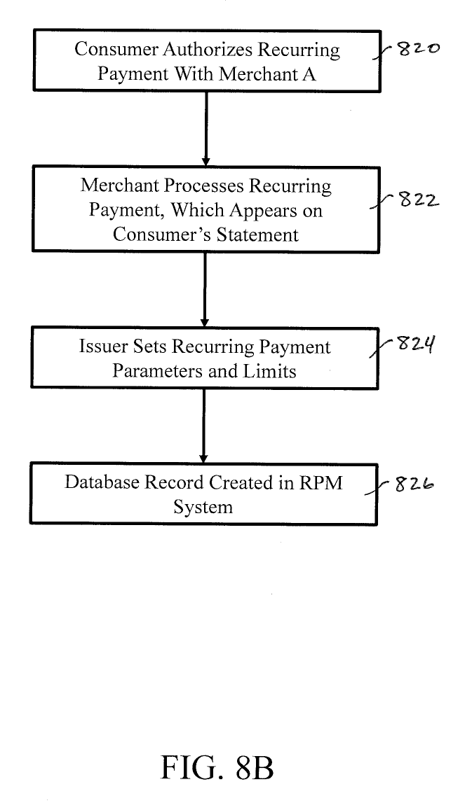

Aspects of the present invention (described in more detail below) are invoked when a merchant 10 submits a request for a recurring payment. Each merchant 10 will typically maintain a merchant recurring payment system 60 comprised of a server 62 and a database 64 having a plurality of database entries (i.e., data structures) for each of the consumers 30 that have authorized a recurring payment to the merchant 10. The database entries include particulars of the recurring payments. When a merchant 10 processes its recurring payments (at whatever periodicity), the merchant 10 transmits recurring payment requests based on instructions stored in the database 64 to its acquirer bank 70 at 12 of FIG. 4, typically in batch form. Such requests pass through the cashless transaction card network 90 directly to the issuer 40, in prior art systems. In accordance with embodiments of the present invention, the RPM system 20 is operational within the cashless transaction card network 90 and receives the requests from the acquirer bank 70 (on behalf of the merchant 10), at step 402. At this point the present invention is architecturally (computer architecture) and operationally different from prior art recurring payment transactions. While recurring payment transaction requests already pass through the cashless transaction card network 90, and are identified as such via a recurring payment flag or other designated data element in the transaction request, the RPM system 20 of the present invention takes control of such requests where a consumer 30 has previously created an account with the RPM system 20. A consumer 30, having previously authorized a recurring payment with a merchant 10 at step 400 and 32 of FIG. 4, will now be involved in the process of approving or denying the request for a recurring payment from the merchant 10 if the consumer 30 has also previously created an account with the RPM system 20 via the issuer 40 (as described below and as depicted in FIGS. 8A and 8B). A server 22 and a database 24 of the RPM system 20 carry-out aspects of the present invention. Each consumer 30 that has created an account with the RPM system 20 will have a database record 80 for a consumer account 82. A consumer 30 may have a database record 80 for each cashless transaction card for which the consumer 30 desires to utilize the present invention or a single database record 80 may have entries for a plurality of cashless transaction cards of the consumer 30. The database record 80 will contain an entry 84 for at least one merchant 10, a recurring payment amount limit 86 the consumer has pre-approved for a recurring payment for that merchant 10 (i.e., an allowable amount), and an allowable variation 88 of the payment amount limit 86. When the request for a recurring payment transaction is received by the RPM system 20 at step 402, the database 24 is checked, at step 406, to determine if there is a database record 80 for the consumer 30 for which the recurring payment transaction is directed. If there is no database record 80 for the consumer 30, the recurring payment transaction request is processed per the prior art, at step 404. If there is a database record 80 for the consumer 30 and that record corresponds to the consumer account 82 and has an entry for the merchant 10, the RPM system 20 compares, at step 422, the amount requested by the merchant 10 for the recurring payment with the amount limit 86 (plus or minus the allowable variation 88, of applicable) in the database entry 84 for the merchant 10. If the amount requested is allowable, i.e., the recurring payment amount is for an amount that has been pre-approved by the consumer 30 either as a recurring payment amount limit 86 or a recurring payment amount limit 86 plus or minus the allowable variation 88, if applicable, as determined by the RPM system 20 at step 410, the recurring payment is approved at step 408, and the request is communicated by the RPM system 20 to the issuer 40, at step 416. The issuer 40 then completes the recurring payment transaction request in ordinary fashion, paying the merchant at step 420 via the acquirer bank 70 at 44 of FIG. 4, and notifying the consumer 30 at step 418 via a monthly statement, for example. If the RPM system 20 determines, at step 410, that the amount requested in the recurring payment transaction request is not allowable, i.e., the recurring payment amount is for an amount that has not been pre-approved by the consumer 30 either as a recurring payment amount limit 86 or a recurring payment amount limit 86 plus or minus the allowable variation 88, the RPM system 20 notifies the consumer 30 at step 412 and interface 28 of FIG. 4, and requests that the consumer 30 provide further instructions regarding the request. The interface 28 may be of any known type that permits input and output of data with the consumer 30, including, but not limited to, graphical user interfaces (GUIs), clickable buttons, selectable pull-down menu elements, touch-screens, keyboards, touch pads, mouses, and the like. In addition, the interface 28 may be configured for any form of communication, including, e-mail, SMS, web-based, alerts, and so forth. Specifically, the consumer 30 may, at step 414, provide to the RPM system 20 an instruction, e.g., via the interface 28, to approve or deny the request. The consumer 30 can approve or deny the transaction request for this request only, or for this request and all future requests for this recurring payment. If the consumer 30 provides an instruction for this request only, as determined at step 430 of FIG. 6B, the RPM system 20 determines whether the instruction is to approve or deny the request, at step 454. If the consumer 30 has approved the request for this request only, the RPM system 20 proceeds as described above for a consumer approved request to notify the issuer 40 at step 416 paying the merchant 10 at step 420 and notifying the consumer 30 at step 418. If, on the other hand, the consumer 30 has denied the request for this request only, as per step 454, the RPM system 20 notifies the issuer 40 at step 436 and the merchant 10 at step 438.

If the consumer 20 has provided an instruction for this request and all future requests, as determined at step 432, the RPM system 20 determines whether the consumer 30 has approved or denied the request, at step 456. If the consumer 30 has approved the request, the RPM system 20 proceeds as described above for a consumer approved request to notify the issuer 40 at step 416, and the issuer 40 paying the merchant 10 at step 420 and notifying the consumer 30 at step 418. In addition, the RPM system 20 updates the RPM system database 24, at step 434, so that the amount limit 86 is updated to reflect the amount received in the recurring payment transaction request and approved by the consumer 30. That amount becomes a new amount limit 86 for the specific merchant 10 that transmitted the current recurring payment transaction request. If, on the other hand, the consumer 30 instruction is to deny this request and all future requests from this merchant 10 for this transaction, as determined at step 456, the RPM system 20 notifies the issuer 40 at step 436, the merchant 10 at step 438, and updates the RPM database 24 at step 434 accordingly so that all future recurring payment requests from this merchant 10 for this consumer 30 and consumer account number 82 will be denied by the RPM system 20. That is not to say that the recurring payment is cancelled with the merchant 10, but merely that future recurring payments will not be processed by the RPM system 20 in accordance with embodiments of the present invention. In addition, a consumer 30 may voluntarily opt-out of using the RPM system 20 by accessing the consumer account and editing or modifying the consumer profile.

A consumer 30 desiring to take advantage of benefits of the present invention must first have an account with the RPM system 20. A consumer 30 may create an account in the RPM system 20, or an account may be created for the consumer, e.g., using the interface 28. These options are depicted in FIGS. 8A and 8B, respectively. Referring first to FIG. 8A, a process by which a consumer 30 creates an entry in the RPM system 20 begins with the consumer 30 authorizing a recurring payment with a merchant 10, at step 802 (see also step 400 of FIG. 6A). Once approved by the consumer 30, the transaction for the recurring payment is processed by the merchant 10 and appears on the consumer's monthly statement from the issuer 40 at step 804. To facilitate use of recurring payments, the issuer 40 may provide consumers with access to the RPM system 20 via a portal, web-site, and the like as the interface 28. At step 806, a consumer 30 can log into the issuer portal either to create or to manage an account on the RPM system 20. The issuer 40 may provide a graphical user interface as the interface 28 for use by the consumer 30 to interact with the RPM system 20, at step 808, and to create, edit, modify, etc. the consumer account (e.g., a consumer profile, amounts, merchants, etc.). Consumer interaction can mean either or both of creating an account and managing an account on the RPM system 20. At step 810, the consumer 30 can set limits and parameters for one or more recurring payments with one or more merchants 10. Limits may include, by way of non-limiting example, a payment amount limit 86 and an allowable variation 88. Parameters may include, by way of non-limiting example, merchant names and identifiers, consumer account numbers, and consumer name and contact information. When using the issuer portal to create an account on the RPM system 20, a database record 80 (see, e.g., FIG. 4) is created in the database 24 of the RPM system 20, containing at least a consumer identification or account number 82, a merchant identifier 84, and a recurring payment limit amount 86, at step 812.

Alternatively, and as depicted in FIG. 8B, an account may be created for the consumer 30 on the RPM system 20 after the consumer 30 has approved the recurring payment, as in step 820. Once approved by the consumer 30, the transaction for the recurring payment is processed by the merchant 10 and appears on the consumer's monthly statement from the issuer 40, as in step 822, and as with the process of FIG. 8A, the consumer 30 again has access to the RPM system 20 via a portal or website provided by the issuer 40. In this case, the consumer account was auto-created without direct consumer involvement. This may occur through interaction between a merchant (or merchant bank (i.e., acquirer)) and an issuer after a consumer has authorized a recurring payment with a merchant. The consumer 30 may access the RPM system 20 via the interface 28, e.g., issuer portal or website, to set or modify the parameters or limits for one or more recurring payments. In this embodiment, the issuer 40, via the RPM system 20, sets limits and parameters on behalf of the consumer 30 for an authorized recurring payment at step 824. A database record 80 (see, e.g., FIG. 4) is created in the database 24 of the RPM system 20, containing at least a consumer identification or account number 82, a merchant identifier 84, and a recurring payment limit amount 86, at step 826.

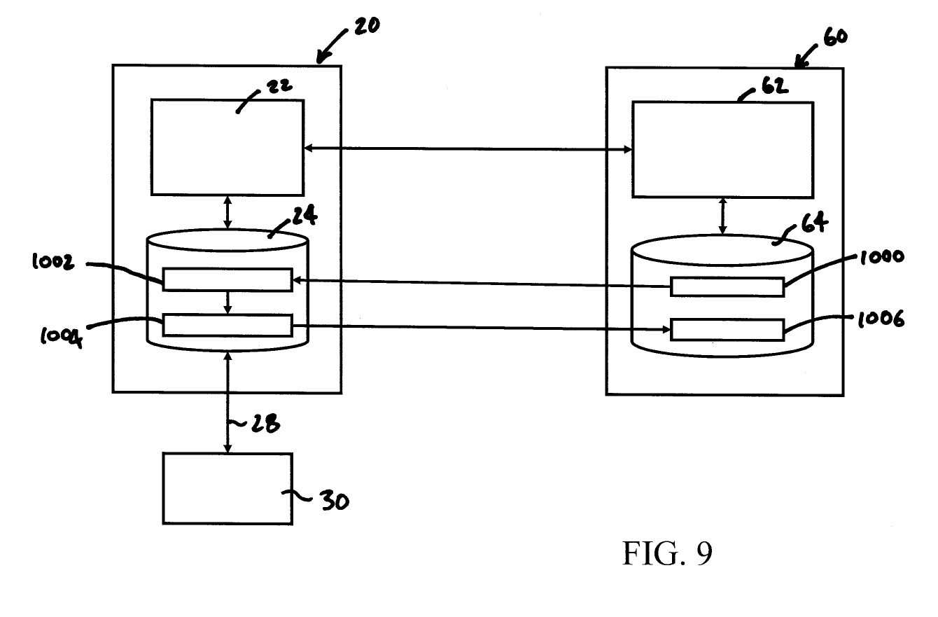

As a further embodiment, and as depicted in FIG. 9, the RPM system 20 may be configured to react to change requests to the recurring payment instructions stored in the database 64. In this manner, the base recurring payment instructions may be modified with acceptability to the consumer 30. Here, the merchant would submit a request for change to the RPM system 20, e.g., through the server 62, with the details of the requested change. The change request may be to the amount of the recurring payment, the frequency of payment, the mode of payment, and any other possibly related parameter. With reference to FIG. 9, once the RPM system 20, e.g., by the server 22, receives the change request, the relevant data structure 1000 is removed from the database 64 and replicated in the database 24 of the RPM system 20 as replicated data structure 1002. In this manner, the merchant loses the ability to request payment for this matter. The requested change is communicated to the consumer 30 via the interface 28. This may be in the form of a transmitted query requesting approval or denial of the change request. The consumer 30 transmits a response to the RPM system 20 via the interface 28. If the change request is approved, the server 20 causes the replicated data structure 1002 to be updated to updated data structure 1004 which contains terms consistent with the change request terms. In turn, the updated data structure 1004 is replicated on the database 64 as final data structure 1006 to allow for future recurring payment requests based on the updated payment terms. The updated data structure 1004 may be deleted from the database 24 once replicated on the database 64. Approval by the consumer 30 may be one-time or permanent. If one-time, the final data structure 1006 stored on the database 64 may be tagged as such to be limited to a one-time use.

If the consumer 30 denies the change request, the replicated data structure 1002 on the database 24 is not updated and the merchant may be notified. The final data structure 1006 may be created on the database 64 as a re-creation of the original data structure 1000, if the merchant seeks to continue with the payment terms, as unchanged, with possible deletion of the replicated data structure 1002 on the database 24. The consumer 30 may be given the option to altogether cancel the recurring payment. If so, the replicated data structure 1002 is deleted from the database 24 with no further action relative thereto.

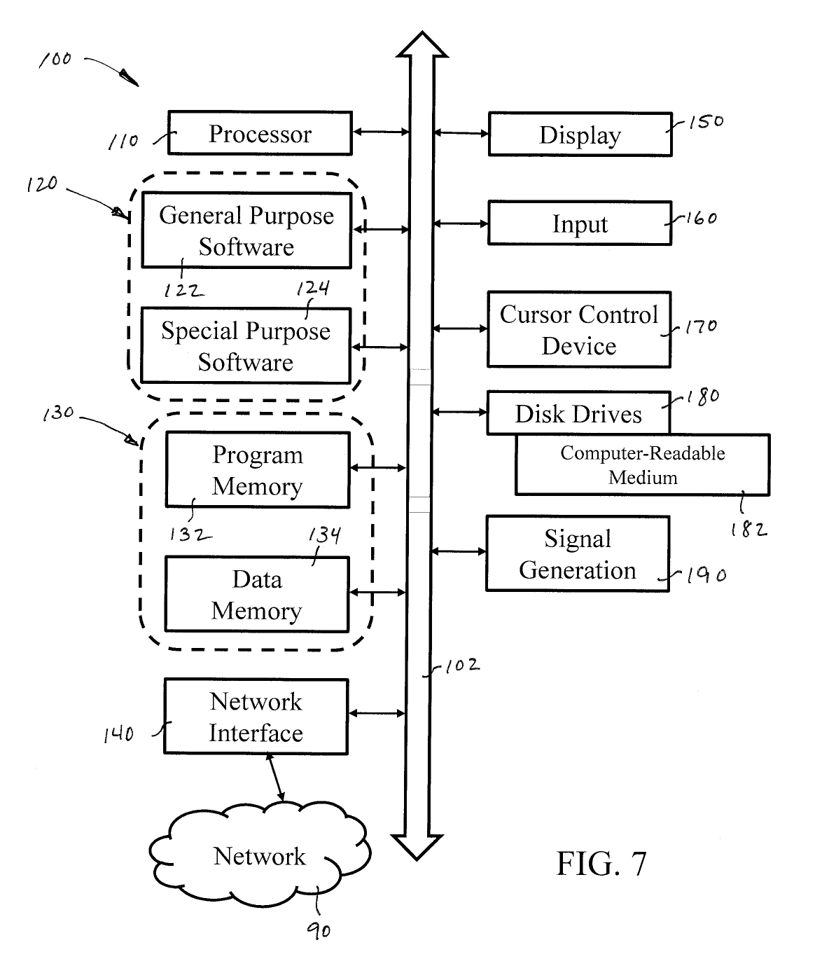

Referring next to FIG. 7, a server 100 in accordance with embodiments of the present invention will now be discussed in more detail. The server 100 may be a general purpose computing device having a plurality of devices and components operably connected over a bus 102. The server 100 has one or more processors 110 or central processing units (“CPU”). Although the server 100 of the present invention is discussed as having a single processor 110, a server having multiple processor, either separate or integrated in a multi-core processor, for example, are also contemplated by and within the scope and spirit of the present invention. Reference to processor in the singular herein shall be interpreted to include any variation and number of processors. The processor 110 is operable by at least one program of instructions 120 comprising general purpose software 122 to carry out functions that enable the server 100 to interface with its various hardware components (discussed further below), and to interface and communicate with other devices. The processor 110 of the present invention is also operable by at least one program of instructions 120 comprising special purpose software 124 to carry out aspects of the present invention. The general purpose software 122 and special purpose software 124 may be stored on the server 100 in memory 130 that may comprise program memory 132 and data memory 134, or it may be stored on one or more disk drives 180 comprised of a computer-readable medium 182, or it may be stored in/on any combination of the foregoing. As used herein, the term “memory” is intended to include all currently known or hereafter developed types of permanent or temporary storage devices or components in a computing device. Exemplary memory types include, by way of illustration and not limitation, Random Access Memory (RAM)—further including Dynamic RAM (DRAM), Static RAM (SRAM), and Direct Rambus DRAM (DRDRAM), Read Only Memory (ROM)—further including Programmable ROM (PROM), erasable PROM (EPROM), and Electrically EPROM (EEPROM), cache memory, hard drives and flash memory.

The server 100 further includes a display 150, input device(s) 160 (e.g., a keyboard), cursor control device(s) 170 (e.g., a mouse), signal generation device(s) 190 (e.g., a speaker or remote control), and network interface device(s) 140 that enable the server 100 to selectively connect to and with a network 90 and send or receive voice, video or data, and to communicate over the network 90 as controlled by the program of instructions 120.

The memory 130 and disk drives 180 each comprise computer-readable medium 182 that may each include a single medium or multiple media (e.g., a centralized or distributed database, and/or associated caches and servers) that store the one or more programs of instructions 120. As used herein, the term “computer-readable medium” means and includes, but is not limited to, solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives that is considered a distribution medium equivalent to a tangible storage medium. Accordingly, the embodiment is considered to include anyone or more of a tangible computer-readable medium or a tangible distribution medium, as listed herein and including art-recognized equivalents and successor media, in which the software implementations herein are stored. The term “computer-readable medium” also means and includes any medium that is capable of storing, encoding, or carrying a set of instructions in the general purpose software 122 and in the special purpose software 124.

Although the present specification may describe components and functions implemented in the embodiments with reference to particular standards and protocols, the disclosed embodiments are not limited to such standards and protocols.

In accordance with various embodiments, the present invention may be implemented as one or more software programs running on one or more computing devices and one or more computer processors. Dedicated hardware implementations including, but not limited to, application specific integrated circuits, programmable logic arrays and other hardware devices can likewise be constructed to implement the present invention. Furthermore, alternative software implementations including, but not limited to, distributed processing or component/object distributed processing, parallel processing, or virtual machine processing can also be constructed to implement the present invention.

As used herein, the term “connectable” refers to various states of connection between electronic devices. For example, “connectable” refers to a physical connection between electronic devices, a wireless connection between electronic devices, a combination of a physical and wireless connection between electronic devices, a transient or episodic connection between electronic devices. As used herein the term “connectable” also refers to various states of connectivity between electronic devices such as, by way of non-limiting example, when electronic devices are not connected, when electronic devices are connecting, and when electronic devices are connected.

Modifications to embodiments of the present invention are possible without departing from the scope of the invention as defined by the accompanying claims. Expressions such as “including,” “comprising,” “incorporating,” “consisting of,” “have,” “is,” used to describe and claim the present invention are intended to be construed in a non-exclusive manner, namely allowing for articles, components or elements not explicitly described herein also to be present. Reference to the singular is to be construed to relate to the plural, where applicable.

Although specific example embodiments have been described, it will be evident that various modifications and changes may be made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A system for managing a recurring payment between a merchant and a consumer, the consumer having an account with an issuer and the recurring payment being requested by the merchant on the consumer account, the system comprising:
a database containing a plurality of database records for a plurality of consumer accounts, each database record for each of the plurality of consumer accounts containing a merchant identifier and a recurring payment amount limit; and
a server in communication with the consumer, a plurality of merchant recurring payment systems, and the database, the server having a processor and memory, the processor being operable by a program of instructions stored in the server memory, wherein the program of instructions, when executed by the processor causes the processor to:
receive a request for a recurring payment transaction for the consumer account and for a recurring payment amount;
determine whether the database contains a database record for the consumer account;
when the database contains a database record for the consumer account:
determine whether the recurring payment amount is an amount pre-approved by the consumer;
when the recurring payment amount is an amount that is not pre-approved by the consumer:
transmit a message to the consumer; and
receive an instruction from the consumer to one of approve and deny the recurring payment transaction; and
when the recurring payment amount is an amount that is pre-approved by the consumer, authorize the recurring payment transaction.

2. A system according to claim 1, wherein the program of instructions, when executed by the processor, further causes the processor to determine whether the recurring payment amount is an amount pre-approved by the consumer by determining whether the recurring payment amount is different than the recurring payment amount limit.

3. A system according to claim 2, wherein the program of instructions, when executed by the processor, further causes the processor to determine whether the recurring payment amount is an amount pre-approved by the consumer by determining whether the recurring payment amount is greater than the recurring payment amount limit.

4. A system according to claim 3, wherein each database record for each of the plurality of consumer accounts further contains an allowable variation value, and wherein the program of instructions, when executed by the processor, further causes the processor to determine whether the recurring payment amount is an amount pre-approved by the consumer by determining whether the recurring payment amount is greater than the recurring payment amount limit by more than the allowable variation value in the database record for the consumer account.

5. A system according to claim 1, wherein the program of instructions, when executed by the processor, further causes the processor to receive an instruction from the consumer to approve the recurring payment transaction.

6. A system according to claim 5, wherein the program of instructions, when executed by the processor, further causes the processor to receive an instruction from the consumer to approve the recurring payment transaction for one of the recurring payment transaction, and the recurring payment transaction and future recurring payment transactions.

7. A system according to claim 1, wherein the program of instructions, when executed by the processor, further causes the processor to receive an instruction from the consumer to deny the recurring payment transaction.

8. A system according to claim 7, wherein the program of instructions, when executed by the processor, further causes the processor to receive an instruction from the consumer to deny the recurring payment transaction for one of the recurring payment transaction, and the recurring payment transaction and future recurring payment transactions.

9. A system according to claim 1, wherein the program of instructions, when executed by the processor, further causes the processor to transmit a message to the consumer in real-time during the recurring payment transaction.

10. A system according to claim 1, wherein, when the recurring payment amount is an amount that is not pre-approved by the consumer, the program of instructions, when executed by the processor, further causes the processor to modify the database record for the consumer.

11. A method for managing a recurring payment between a merchant and a consumer, the consumer having an account with an issuer and the recurring payment being requested by the merchant on the consumer account, the method being carried out by a system comprising:
a database containing a plurality of database records for a plurality of consumer accounts, each database record for each of the plurality of accounts containing a merchant identifier and a recurring payment amount limit; and
a server in communication with the consumer, a plurality of merchant recurring payment systems, and the database, the server having a processor and memory and the processor being operable by a program of instructions stored in the server memory, wherein the program of instructions, when executed by the processor causes the processor to carry out the method comprising the steps of:
receiving a request for a recurring payment transaction for the consumer account and for a recurring payment amount;
determining whether the database contains a database record for the consumer account;
when the database contains a database record for the consumer account:
determining whether the recurring payment amount is an amount pre-approved by the consumer;
when the recurring payment amount is an amount that is not pre-approved by the consumer:
transmitting a message to the consumer;
receiving an instruction from the consumer to one of approve and deny the recurring payment transaction; and
when the recurring payment amount is an amount that is pre-approved by the consumer, authorize the recurring payment transaction.

12. A method according to claim 11, wherein the step of determining whether the recurring payment amount is an amount pre-approved by the consumer further comprises determining whether the recurring payment amount is different than the recurring payment amount limit.

13. A method according to claim 12, wherein the step of determining whether the recurring payment amount is an amount pre-approved by the consumer further comprises determining whether the recurring payment amount is greater than the recurring payment amount limit.

14. A method according to claim 13, wherein each database record for each of the plurality of consumer accounts further contains an allowable variation value, and wherein the step of determining whether the recurring payment amount is an amount pre-approved by the consumer further comprises determining whether the recurring payment amount is greater than the recurring payment amount limit by more than the allowable variable value.

15. A method according to claim 11, wherein the step of receiving an instruction from the consumer further comprises receiving an instruction from the consumer to approve the recurring payment transaction.

16. A method according to claim 15, wherein the step of receiving an instruction from the consumer further comprises receiving an instruction from the consumer to approve the recurring payment transaction for one of the recurring payment transaction, and the recurring payment transaction and future recurring payment transactions.

17. A method according to claim 11, wherein the step of receiving an instruction from the consumer further comprises receiving an instruction from the consumer to deny the recurring payment transaction.

18. A method according to claim 17, wherein the step of receiving an instruction from the consumer further comprises receiving an instruction from the consumer to deny the recurring payment transaction for one of the recurring payment transaction, and the recurring payment transaction and future recurring payment transactions.

19. A method according to claim 11, wherein the method further comprises the step of transmitting a message to the consumer in real-time during the recurring payment transaction.

20. A method according to claim 11, wherein the method further comprises the step of creating the database.

21. A method according to claim 11, wherein, when the recurring payment amount is an amount that is not pre-approved by the consumer, the method further comprising the step of modifying the database record for the consumer account.

22. A method for managing a recurring payment between a merchant and a consumer, the consumer having an account with an issuer and the recurring payment being requested by the merchant on the consumer account, the method being carried out by a recurring payment management (RPM) system comprising:
a RPM system database containing a plurality of database records for a plurality of consumer accounts, including a record for the consumer account, each database record for each of the plurality of consumer accounts containing a merchant identifier and a recurring payment amount limit; and
a server in communication with the consumer, a plurality of merchant recurring payment systems, and the RPM system database, the server having a processor and memory, the processor being operable by a program of instructions stored in the server memory, wherein the program of instructions, when executed by the processor causes the processor to carry out the method comprising the steps of:
determining when a recurring payment amount in a recurring payment transaction request from the merchant for the consumer is different than the recurring payment amount limit in the RPM system database record for the consumer;
notifying the consumer that the recurring payment amount in the recurring payment transaction request is different than the recurring payment amount limit in the RPM system database record for the consumer;
determining whether the consumer one of approves and denies the recurring payment transaction; and
approving or denying the recurring payment transaction request.

23. A method according to claim 22, further comprising the step of determining whether the recurring payment amount in the recurring payment transaction request is greater than the recurring payment amount limit.

24. A method according to claim 22, further comprising the step of receiving an instruction from the consumer to one of approve and deny the recurring payment transaction.

25. A method according to claim 24, further comprising the step of receiving an instruction from the consumer to approve the recurring payment transaction for one of the recurring payment transaction, and the recurring payment transaction and future recurring payment transactions.

26. A method according to claim 24, further comprising the step of receiving an instruction from the consumer to deny the recurring payment transaction.

27. A method according to claim 26, further comprising the step of receiving an instruction from the consumer to deny the recurring payment transaction for one of the recurring payment transaction, and the recurring payment transaction and future recurring payment transactions.

28. A method according to claim 22, wherein the step of determining whether the consumer one of approves and denies the recurring payment transaction further comprises receiving an instruction from the consumer to one of approve and deny the recurring payment transaction for one of the recurring payment transaction, and the recurring payment transaction and future recurring payment transactions, and further comprising the step of modifying the RPM database record for the consumer.

29. A system for managing a recurring payment system, the recurring payment system including a recurring payment instructions database containing a plurality of data structures each containing payment instructions for a recurring payment between and a consumer and a merchant, the system comprising:
a holding database;
a processing unit configured to be responsive to change requests transmitted to the recurring payment system, said processing unit being configured such that upon a first change request being transmitted to the recurring payment system requesting to change the payment instructions stored in a first data structure, said processing unit causing removal of said first data structure from said recurring payment instructions database and causing creation of a replicated data structure in said holding database based on replication of said first data structure including said payment instructions of said first data structure; and,
an interface for communicating with a plurality of consumers, said interface being configured to transmit a query to the consumer corresponding to the recurring payment of said first data structure, said query being configured to determine if the consumer approves or disapproves the first change request,
wherein, said interface being configured to receive one or more responses to the query from the consumer,
wherein, if the consumer approves the first change request, said processing unit causing the payment instructions of said replicated data structure to be updated based on said first change request, said updated replicated data structure being replicated in the recurring payment instructions database as a final data structure to be used for one or more future recurring payments.

30. A system according to claim 29, wherein, if the consumer approves the first change request on a one-time basis, said final data structure being tagged to be limited to a one-time use.

31. A system according to claim 29, wherein, if the consumer disapproves the first change request, said processing unit causing said replicated data structure to be deleted.
